(19) United States
(12) Patent Application Publication
(10) Pub. No.: US 2022/0081351 A1
(43) Pub. Date: Mar. 17, 2022

(54) Windshield Protective Coating

(71) Applicants: Kirby King, El Reno, OK (US); Loretta King, El Reno, OK (US)

(72) Inventors: Kirby King, El Reno, OK (US); Loretta King, El Reno, OK (US)

(21) Appl. No.: 17/024,008

(22) Filed: Sep. 17, 2020

(51) Int. Cl. C03C 17/25; C03C 1/00; C03C 8/14; C03C 8/02

(52) U.S. Cl. CPC C03C 17/25; C03C 1/002; C03C 8/14; C03C 2207/00; C03C 2217/29; C03C 2217/78; C03C 2218/13; C03C 8/02

(57) ABSTRACT

A windshield protective coating includes a mixture for positioning on the windshield. The mixture includes silica dioxide, sodium carbonate, dolomite, and cullet and is placed as a coating or a film on the windshield to provide a barrier against damage from small rocks and other objects.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to glass protection coating and more particularly pertains to a new glass protection coating for preventing damage to the outer surface of a windshield.

### (2) Description of Related Art Including Information Disclosed Under 37 CFR 1.97 and 1.98

The prior art relates to glass protection coatings that are applied to a windshield to improve its deflective properties.

### BRIEF SUMMARY OF THE INVENTION

An embodiment of the disclosure meets the needs presented above by generally comprising a mixture for positioning on the windshield. The mixture includes silica dioxide, sodium carbonate, dolomite, and cullet and is placed as a coating or a film on the windshield to provide a barrier against damage from small rocks and other objects.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

Not Applicable

### DETAILED DESCRIPTION OF THE INVENTION

A new glass protection coating embodying the principles and concepts of an embodiment of the disclosure will be described.

The windshield protective coating generally comprises a mixture which is combined, melted and then formed into a film that is positionable on a windshield or is positioned directly onto a windshield as a paste that cools onto and adheres to the windshield. If formed into a film, the film will typically adhere to the glass of a windshield due to cohesion affects or chemical coatings may be utilized to cure the film to the windshield. Such curing chemicals are widely known in the window tinting industry. Alternatively, what is commonly known as a wet adhesive may be utilized. Regardless of the method of positioning the adhering the film to an outside surface of the window, the windshield protective coating is positioned on the outer surface of the windshield to completely cover, to the furthest extent possible, the outer surface of the windshield to reduce chipping and breaking of the windshield.

The coating is comprised of a mixture that may be formed into a film for positioning on the windshield or positioned onto the windshield before solidification. The mixture includes four primary components which are mixed thoroughly together, heated to a sufficient temperature for between 10 minutes and 30 minutes until melted, and then formed into a film having a thickness of less than 4.0 mm or applied to the windshield while in a fluidic state.

The mixture includes:
silica dioxide, commonly referred to as silica or quartz and having an overall chemical formula of SiO₂
sodium carbonate, commonly referred to as soda-ash and having a chemical formula of Na₂CO₃
dolomite found in multiple variations of calcium magnesium carbonate, but typically provided as CaMg(CO₃)₂
cullet, which is glass that is crushed for remelting during the recycling of glass products

In one embodiment, the mixture includes by weight 65% to 75% weight silica dioxide, 5% to 15% sodium carbonate, 5% to 15% dolomite, and 5% to 15% cullet. More particularly, the mixture includes by weight 70% weight silica dioxide, 10% sodium carbonate, 10% dolomite, and 10% cullet.

In use, the mixture may be melted and then spread evenly across a windshield as a “paste” which naturally adheres to the windshield and becomes transparent upon solidifying. The mixture helps to prevent damage to the windshield and more readily deflects small pebbles which my other mar the surface of the windshield.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective layer configured to be positioned on and protect a windshield, said protective layer comprising:
a mixture for positioning on the windshield, said mixture including silica dioxide, sodium carbonate, dolomite, and cullet.

2. The protective layer according to claim 1, wherein the mixture includes by weight:
65% to 75% weight silica dioxide;
5% to 15% sodium carbonate;
5% to 15% dolomite; and
5% to 15% cullet.

3. A protective layer configured to be positioned on and protect a windshield, said protective layer comprising:
a mixture for positioning on the windshield, said mixture including by weight:
70% weight silica dioxide;
10% sodium carbonate;
10% dolomite; and
10% cullet.
